(19) United States
(12) Patent Application Publication
(10) Pub. No.: US 2017/0280260 A1
(43) Pub. Date: Sep. 28, 2017

(54) A METHOD FOR PRODUCING A HEARING DEVICE SHELL, A HEARING DEVICE SHELL AND A HEARING DEVICE

(71) Applicant: Sonova AG, Stafa (CH)

(72) Inventors: Matthias Stadler, Mannedorf (CH); Daniel Probst, Uerikon (CH)

(21) Appl. No.: 15/509,248

(22) PCT Filed: Sep. 8, 2014
(86) PCT No.: PCT/EP2014/069072

§ 371 Date: Mar. 7, 2017

(51) Int. Cl. H04R 25/00

(52) U.S. Cl. CPC H04R 25/658; H04R 25/652; H04R 2225/025; H04R 2225/77

(57) ABSTRACT

A method for producing a hearing device shell includes producing a 3D-model of the shell by using ear canal measurement data; deriving a first set of data from the 3D-model; manufacturing a hearing device shell preform based on the first set of data such to assume an outer surface designed larger than the targeted final shape of the hearing device shell; calculating a second set of data from the 3D-model; and machining the surface of the hearing device shell preform based on the second set of data resulting in the hearing device shell.

### TECHNICAL FIELD

The present invention relates to a method for producing a hearing device shell, a hearing device shell produced by said method and a hearing device.

### BACKGROUND OF THE INVENTION

In hearing device shell manufacturing it is known to modify the model of the hearing device shell in order to compensate for later buffing or tumbling operations. Additive manufacturing is used in the industry to produce custom made shells of In-The-Ear (ITE) hearing devices and Receiver-In-Canal (RIC) hearing devices as well as earpieces. Such additive manufacturing comprises 3D-printing, for example. Further manufacturing methods distinct from additive manufacturing comprise selective laser sintering, selective laser melting, fused deposition modeling, stereolithography, digital light processing, and multi jet modeling, for example.

Document DE 10 2006 007 032 A1 discloses post treatment exerted on a hearing device shell after production thereof.

It is an object of the present invention to provide a method for producing a hearing device shell which method allows to achieve improved surface finishing and thinner walls of the shell. It is a further object of the present invention to produce a hearing device shell and a hearing device providing better comfort and improved fit-rate.

### SUMMARY OF THE INVENTION

The present invention is directed to a method for producing a hearing device shell, comprising: producing a 3D-model of the shell by means of ear canal measurement data; deriving a first set of data from the 3D-model; manufacturing a hearing device shell preform based on the first set of data such to assume an outer surface designed larger than the targeted final shape of the hearing device shell; calculating a second set of data from the 3D-model; and machining the surface of the hearing device shell preform based on the second set of data resulting in the hearing device shell.

In this way, in addition to a single manufacturing step to produce the hearing device shell, a subsequent machining step is introduced in order to accomplish accurate modification of the surface of said shell. Contrary to known technologies, both manufacturing steps are based on two sets of data, i.e. a first set of data and second set of data, derived from the 3D-model.

The present invention uses, in addition to the step of additive manufacturing of the shell, a subsequent step of automated milling/buffing/polishing of the shell in order to modify the surface of the shell such to arrive to the targeted final shape. It is noted that both manufacturing steps are based on the first and second set of data (3D-data) derived from the 3D-model (CAD model). This allows to get an improved surface finishing and to reduce the wall thickness of the shell. As a whole, higher precision of the surface of the shell is achieved, providing more accurate fit to the ear canal.

In an embodiment, the manufacturing step comprises an additive manufacturing. This step is for producing the hearing device shell preform. Hence, a process of making a 3D solid object of virtually any shape from the 3D-model is used successfully.

In an embodiment, the manufacturing step further comprises providing the hearing device shell preform with an opening. This opening might act as any kind of acoustic passage, as well as an opening for providing venting, for example.

In a further embodiment, the manufacturing step comprises one of laser sintering and 3D-printing. In order to produce the hearing device shell preform by using 3D-printing, successive layers of material are laid down in different shapes. This 3D-printing is distinct from traditional machining technics known in the art relying on the removal of the material, for example by means of cutting or drilling.

In a further embodiment, the machining step comprises a subtractive manufacturing. In this step, a powered machining tool, for example a cutting tool or a drilling tool, is used for machining the surface of the manufactured hearing device shell preform using the second set of data, which is essentially designed in the targeted final shape. In this way, a certain shape and surface finishing are achieved properly.

In a further embodiment, the machining step comprises at least one of milling by means of at least one cutting tool, buffing and polishing. The respective machining tool used for cutting, buffing and polishing is mounted to a CNC milling machine, a robot arm or a similar installation, for example. The respective machining tool machines the surface of the hearing device shell according to the second set of data such to accomplish a certain shape and surface finishing.

In a further embodiment, the machining step comprises forming at least one mechanically functional part in the hearing device shell. In doing so, any mechanically functional part can be formed with the body of the hearing device shell integrally. Hence, subsequent steps for mounting separate mechanically functional parts can be omitted. Therefore, working time needed for manufacturing the hearing device shell can be reduced, resulting in higher output and reduced costs.

In a further embodiment, the at least one mechanically functional part comprises flexible means comprising at least one of a spring and flexible joint. Hence, subsequent steps for assembling the spring, flexible joint or further components can be omitted, reducing the risk of erroneous assembly and further reducing assembly time as a whole.

In a further embodiment, the machining step further comprises engraving the surface of the hearing device shell. Hence, during the machining step, in addition to machining the surface of the hearing device shell preform by a cutting tool, for example, the used cutting tool further engraves the surface of the hearing device shell. Hence, working time can be reduced. The engraving may comprise a brand name, serial number, patient number and artwork, proper engraved into the surface of the hearing device shell.

In a further embodiment the hearing device shell is manufactured by using titanium. Titanium involves excellent properties for the inventive production method since it allows for thin walls. A further advantage provided by using titanium is that this material can normally be in contact with the skin without provoking irritations.

In a further embodiment the method further comprises polishing the surface of the hearing device shell. Polishing the surface of the hearing device shell provides proper surface finishing.

Moreover, the present invention is directed to a hearing device shell produced by a method according to one of claims 1 to 11. The hearing device shell manufactured by the present invention provides higher precision of the surface, accomplishing more accurate fit to the individual's ear canal.

In an embodiment the hearing device shell is made of titanium. By using titanium, a hearing device shell can be achieved comprising thin walls. Further, titanium allows to be in permanent contact with the individual's skin without provoking irritations.

Moreover, the present invention is directed to a hearing device comprising at least one hearing device transducer and electronics embedded in a hearing device shell according to claim 12 or 13. Hence, a hearing device is proposed which properly fits to the individual's ear canal.

It is expressly pointed out that any combination of the above mentioned embodiments is subject of further possible embodiments. Only those embodiments are excluded that would result in a contradiction.

### BRIEF DESCRIPTION OF THE DRAWINGS

The present invention is further described with reference to the accompanying drawings illustrating an exemplary embodiment which is to be considered in connection with the following detailed description. What is shown in the figures is the following:

FIGS. 1a,b are schematic views illustrating a method for producing a hearing device shell.

### DETAILED DESCRIPTION OF THE INVENTION

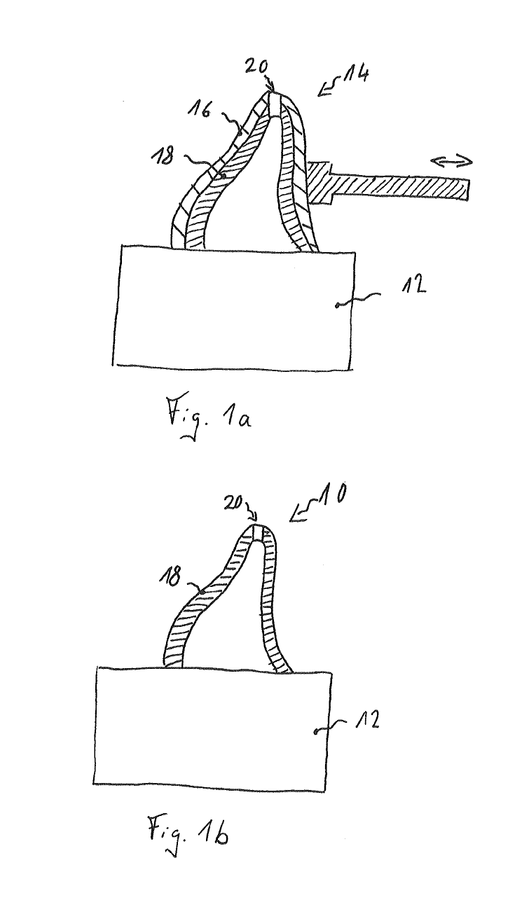

FIGS. 1a,b schematically depict a method for producing a hearing device shell 10 (refer to FIG. 1b) according to the present invention. Previous to the production, non-shown preparations are necessary in order to measure the individual's ear canal. In doing so, the individual's ear canal is scanned by means of an ear canal digital scanner resulting in ear canal measurement data. As an alternative, an ear canal impression can be taken by filling impression taking material into the ear canal and taking out the impression after being cured. In a subsequent step (non-shown), this cured impression taking is scanned by a 3D-scanner, for example, resulting in ear canal measurement data.

Each of the ear canal measurements mentioned above results in ear canal measurement data. Subsequent, the ear canal measurement data is converted to produce a 3D-model of the hearing device shell 10. From the 3D-model a first set of data is derived which is used for a subsequent production step. In this production step, on a stage 12, a hearing device shell preform 14 is manufactured based on the first set of data such to assume an outer surface 16 defined larger than the targeted final shape 18 of the hearing device shell 10. In other words, a hearing device shell preform 14 or rather custom manufactured hearing device shell is manufactured.

Advantageously, this manufacturing step comprises additive manufacturing comprising laser sintering or 3D-printing, for example. The custom manufactured hearing device shell is used to obtain the outer surface 16 which is designed larger than the targeted final shape 18. The hearing device shell preform 14 may be provided with an opening 20 as a vent or any kind of acoustic passage, for example.

In a subsequent step, a second set of data is calculated from the 3D-model mentioned above. After acquisition of the second set of data, the surface of the hearing device shell preform 14 is machined based on this data. In other words, the outer surface 18 previously designed larger than the targeted or rather final shape 16 is machined by a subtractive manufacturing. This subtractive manufacturing machining step comprises milling by means of at least one tool 22 comprising a cutting tool (refer to FIG. 1a).

Further comprised are steps of buffing and polishing the outer surface 18, for example. Therefore, the hearing device shell preform 14 (refer to FIG. 1a) assumes the targeted or rather final shape 18 to become the hearing device shell 10 (refer to FIG. 1b). Hence, according to the present invention, excellent finishing is achieved resulting in proper fitting-rate.

On the contrary, in the prior art, as to manufacturing the hearing device shell solely by means of 3D-printing, limited printing accuracy is an issue. Further, the printing accuracy tends to be non-isometric and depends on part orientation during the build. Further, in the prior art, as to manufacturing the hearing device shell solely by means of laser sintering, the surface becomes rough due to the layer composition as well as particles sticking on the surface.

The post-treatment described in prior art document DE 10 2006 007 032 is for compensating irregularities of the hearing device shell. However, as for the wall thickness, the minimal wall thickness is limited to the respective manufacturing technology. In order to smoothen the surface of the hearing device shell, a manual or an automated process is used. However, the manual process is laborious and results in increased costs and reduced reliability. Further, the possibility of process errors is increased. Besides, the automated process mentioned above used to smoothen the surface of the hearing device shell tends to be uncontrolled and leads to an uneven abrasion of a piece of the hearing device shell.

In an aspect of the invention, in the course of subtractive manufacturing machining, at least one mechanically functional part in the hearing device shell is formed such to be integral with the shell body. Said part comprises flexible means including at least one of a spring and flexible joint, for example. In a further aspect, the surface of the hearing device shell can be engraved. This engraving comprises at least one label, for example a brand name. Further, a serial number, a patient number and/or an artwork can be engraved into the surface.

The hearing device shell can be manufactured by using titanium providing excellent properties since titanium allows for thin walls and can normally be in contact with the skin without provoking irritations. Further, the titanium surface of the hearing device shell can be polished in the course of surface finishing.

Hence, a hearing device shell is produced showing advantageous properties in view of accurate and excellent fit to the individual's ear canal. Compared to the state of the art, the hearing device shell production requires less time and incurs reduced costs. The hearing device shell according to the present invention is configured to accommodate at least one hearing device transducer and electronics used for operation in a hearing device, in particular an In-the-Ear (ITE) hearing device, a Receiver-In-Canal (RIC) hearing device, ear pieces, etc.

What is claimed is:

1. A method for producing a hearing device shell (10), comprising:
producing a 3D-model of the shell (10) by means of ear canal measurement data;
deriving a first set of data from the 3D-model;
manufacturing a hearing device shell preform (14) based on the first set of data such to assume an outer surface (18) designed larger than the targeted final shape (16) of the hearing device shell (10);
calculating a second set of data from the 3D-model; and
machining the surface of the hearing device shell preform (18) based on the second set of data resulting in the hearing device shell (10).

2. The method according to claim 1, wherein the manufacturing step comprises an additive manufacturing.

3. The method according to claim 1, wherein the manufacturing step further comprises providing the hearing device shell preform (14) with an opening (20).

4. The method according to claim 1, wherein the manufacturing step comprises one of laser sintering and 3D-printing.

5. The method according to claim 1, wherein the machining step comprises a subtractive manufacturing.

6. The method according to claim 1, wherein the machining step comprises at least one of milling by means of at least one cutting tool, buffing and polishing.

7. The method according to claim 1, wherein the machining step comprises forming at least one mechanically functional part in the hearing device shell (10).

8. The method according to claim 7, wherein the at least one mechanically functional part comprises flexible means comprising at least one of a spring and flexible joint.

9. The method according to claim 1, wherein the machining step further comprises engraving the surface of the hearing device shell (10).

10. The method according to claim 1, wherein the hearing device shell (10) is manufactured by using titanium.

11. The method according to claim 10, further comprising polishing the surface of the hearing device shell (10).

12. A hearing device shell (10) produced by a method according to claim 1 made to accurate fit to the individual's ear canal.

13. The hearing device shell (10) according to claim 12 made of titanium.

14. A hearing device comprising at least one hearing device transducer and electronics embedded in a hearing device shell (10) according to claim 12.
